(19) United States
(12) Patent Application Publication
(10) Pub. No.: US 2024/0418625 A1
(43) Pub. Date: Dec. 19, 2024

(54) METHOD, SYSTEM, AND COMPUTER-READABLE MEDIUM FOR OPERATING AND MONITORING THE CLEANING OF SAMPLE PROCESSING INSTRUMENTS

(71) Applicant: Beckman Coulter Biotechnology (Suzhou) Co., Ltd., Suzhou, Jiangsu (CN)

(72) Inventors: Lifeng LIU, Suzhou, Jiangsu (CN); Fei WU, Suzhou, Jiangsu (CN); Liang SHI, Suzhou, Jiangsu (CN); Linqun TANG, Suzhou, Jiangsu (CN)

(73) Assignee: Beckman Coulter Biotechnology (Suzhou) Co., Ltd., Suzhou, Jiangsu (CN)

(21) Appl. No.: 18/702,316

(22) PCT Filed: Aug. 17, 2022
(86) PCT No.: PCT/CN2022/113006

§ 371 Date: Apr. 17, 2024

(30) Foreign Application Priority Data
Oct. 20, 2021 (CN) 202111223982.7

(51) Int. Cl. G01N 15/14; G01N 15/1409

(52) U.S. Cl. CPC G01N 15/1425; B01L 13/02; G01N 15/1409; B01L 2200/141

(57) ABSTRACT

Provided is a method for operating and cleaning a sample processing instrument comprising steps, performed by a control device, of: directing a first sample comprising first particles through a flow cell in the sample processing instrument; processing the first sample; cleaning the flow cell of the sample processing instrument with a cleaning agent; measuring a carryover amount in the flow cell after the cleaning, wherein the carryover amount comprises a measurement associated with an amount of the first particles remaining in a measurement region of the flow cell; comparing the measured carryover amount against a predetermined target value, wherein the target value corresponds to a value indicative of a cleaning requirement; and determining, based on the comparison, whether the cleaning requirement is met. Provided are further method for monitoring cleaning of a sample processing instrument, system for operating and cleaning a sample processing instrument, sample processing instrument and computer-readable medium.

### FIELD

The present disclosure relates to a method or system for operating and cleaning a sample processing instrument and a sample processing instrument including the system, e.g., a flow cytometer sorter or analyzer.

### BACKGROUND

This section only provides background information related to the present disclosure, which is not necessarily prior art.

A sample processing instrument is usually configured to analyze a liquid sample including small suspended particles (e.g., biological particles such as extracellular vesicles, non-biological particles such as beads) or cells and/or to sort the particles or cells therein. The sample processing instrument generally processes multiple samples, and after a sample is processed, it needs to be cleaned to avoid inaccurate processing results for the next sample.

Some sample processing instruments are known to be cleaned with the use of sheath fluid. However, the sheath fluid is not necessarily suitable for all types of samples. In other words, some samples may not be cleaned well. If another cleaning agent is used to clean the sample processing instrument, it may be necessary to manually load the cleaning agent into the sample processing instrument, for example, in a semi-automatic loader. This may significantly reduce the cleaning efficiency.

In addition, it is not easy for users to accurately monitor and learn the result of cleaning with respect to traditional sample processing instruments. This is disadvantageous for detection of samples, especially, samples that contain small particles (e.g., nanoparticles) that are not easily cleaned.

### SUMMARY

This section provides a general summary of the disclosure and is not a comprehensive disclosure of its full scope or all of its features.

An object of the present disclosure is to provide a method and system capable of automatically running and cleaning a sample processing instrument between different samples processed by the sample processing instrument.

Another object of the present application is to provide a method capable of automatically and continuously monitoring the cleaning of a sample processing instrument.

Yet another object of the present application is to provide a method that is convenient for users to operate and intuitively monitor the cleaning of the sample processing instrument.

According to an aspect of the present application, there is provided a method for operating and monitoring the cleaning of a sample processing instrument, comprising steps, performed by a control device, of: directing a first sample through a flow cell in the sample processing instrument, wherein the first sample comprises first particles; processing the first sample; cleaning the flow cell of the sample processing instrument with a cleaning agent; measuring a carryover amount in the flow cell after the cleaning, wherein the carryover amount comprises a measurement associated with an amount of the first particles remaining in a measurement region of the flow cell; comparing the measured carryover amount against a predetermined target value, wherein the target value corresponds to a value indicative of a cleaning requirement; and determining, based on the comparison, whether the cleaning requirement is met.

In some embodiments according to the present application, the method further comprises: repeating the cleaning step when it is determined that the cleaning requirement is not met; and stopping a cleaning process when it is determined that the cleaning requirement has been met or when the number of cleaning reaches a maximum threshold.

In some embodiments according to the present application, the target value is input by a user.

In some embodiments according to the present application, the cleaning step comprises selecting a cleaning agent from a plurality of cleaning agents configured to clean the flow cell.

In some embodiments according to the present application, at least one of the cleaning agents comprises a sheath liquid.

In some embodiments according to the present application, the measuring step comprises: pumping the monitoring solution through the flow cell; and measuring light scattered from within the flow cell, wherein the measured light corresponds to the carryover amounts in the flow cell.

In some embodiments according to the present application, the monitoring solution is different from the cleaning agent. In some embodiments, the monitoring solution is water. In other embodiments, the monitoring solution is a buffer.

In some embodiments according to the present application, the measuring comprises: measuring a count of carryovers and/or monitoring a volume of monitoring solution.

In some embodiments according to the present application, the carryover amount may be a count of carryover particles. In some embodiments the count of the carryover particles and/or the volume of the monitoring solution is the total count of carryover particles and/or the total volume of monitoring solution measured during a monitoring period, or a count of carryover particles and/or a volume of monitoring solution measured at predetermined intervals during the monitoring period.

In some embodiments according to the present application, the method further comprises calculating, by the control device, based on the measured carryover amount, a value representative of relevance of the carryover amount to the monitoring solution (e.g., a value of concentration of the carryovers in the monitoring solution) and/or a value representative of relevance of the carryover amounts after cleaning and an amount of the first particles in a sample before cleaning (e.g., a value of ratio of the carryovers to the particles).

In some embodiments according to the present application, the method further comprises calculating a ratio of the carryover amount after the cleaning to an amount of the first particles detected in the first sample, or a ratio of a concentration of the carryovers measured after cleaning to a concentration of the first particles in the first sample.

In some embodiments according to the present application, the method further comprises: directing a second sample through the sample processing instrument following the determination that the cleaning requirement is met; and processing the second sample.

In some embodiments according to the present application, the second sample is directed through the sample processing instrument automatically by the control device in response to the determination that the cleaning requirement is met.

In some embodiments according to the present application, the first particles comprise biological nanoparticles.

In some embodiments according to the present application, the sample processing instrument is a flow cytometer, and wherein processing the first sample comprises determining one or more properties of the first particles in the first sample by directing an optical beam toward the flow cell and measuring light emitted or scattered from within the flow cell.

In some embodiments according to the present application, the method further comprises providing a user interface for being operated by a user and displaying information to the user.

In some embodiments according to the present application, before the cleaning, an operation window is displayed on the user interface for a user to operate, and wherein the operation window comprises at least one of: options for selecting a process to be run, dialog boxes for inputting parameters and/or target values associated with the selected option, and fields for setting cleaning standards for cleaning/monitoring a flow cells after a particular sample is processed (e.g., as described below with respect to FIG. 17, one or more particular samples may be selected and specific cleaning standards may be specified for the particular samples).

In some embodiments according to the present application, during the cleaning or the measuring, a status window is displayed on the user interface, and wherein a running status is displayed on the status window.

In some embodiments according to the present application, after the measuring, a result viewing window is displayed on the user interface, and wherein a running result is displayed on the result viewing window.

In some embodiments according to the present application, measured carryover amount is displayed in real time on the user interface.

In some embodiments according to the present application, control buttons are provided on the windows of the user interface for controlling a next activity.

According to another aspect of the present application, there is provided a method for operating and monitoring the cleaning of a sample processing instrument, comprising, by a computing system associated with the sample processing instrument: displaying, on a user interface, a menu comprising at least one next-activity element; displaying, on the user interface, a parameter setting element in response to a user selection of the at least one next-activity element, wherein the parameter setting element is configured to set a target carryover amount in a flow cell of the sample processing instrument; receiving a user input at the parameter setting element, wherein the user input specifies the target carryover amount; receiving carryover data corresponding to a measurement of particles present in a monitoring solution within the flow cell; deriving an actual carryover amount according to the received carryover data; and displaying, on the user interface, one or more monitoring elements representing the measured carryover amount, the actual carryover amount and/or the target carryover amount.

In some embodiments according to the present application, the method further comprises: determining a cleaning level by comparing the actual carryover amount with the target carryover amount; and displaying, on the user interface, the cleaning level. The cleaning level comprises a first level indicating that a cleaning requirement is met and a second level indicating that the cleaning requirement is not met.

In some embodiments according to the present application, the method further comprises, when the second level is determined, repeating a cleaning cycle and then a monitoring cycle until maximum cleaning cycles are reached. Receiving the user input comprises inputting parameters associated with the cleaning cycle and the monitoring cycle at the parameter setting element, and wherein the parameters comprise the maximum cleaning cycles.

In some embodiments according to the present application, the method further comprises displaying, on the user interface, status of the cleaning cycle and the monitoring cycle.

In some embodiments according to the present application, the status of the cleaning cycle and the monitoring cycle comprises running process of the cleaning cycle, the number of the cleaning cycle which is performing, and running process of the monitoring cycle.

In some embodiments according to the present application, the monitoring elements comprise a graph showing the measured carryover data.

In some embodiments according to the present application, the graph comprises a histogram, a scatter dot plot, a density plot, a pseudocolor plot, or a contour plot.

In some embodiments according to the present application, the graph shows carryover signal intensity vs carryover count.

In some embodiments according to the present application, the parameter setting element is further configured to set a cleaning standard for cleaning/monitoring a flow cells after a particular sample is processed (e.g., as described below with respect to FIG. 17, one or more particular samples may be selected and specific cleaning standards may be specified for cleaning the particular samples).

In some embodiments according to the present application, the parameter setting element comprises a dialog box, a text field, a slider element, a dropdown list, and/or a radio button.

In some embodiments according to the present application, the method further comprises: displaying, on the user interface, a setting-applicable-sample element in response to a user selection of the at least one next-activity element, wherein the setting-applicable-sample element is configured to specify samples to be monitored with the same user input at the parameter setting element; and receiving at the setting-applicable-sample element a user input to specify the samples to which the same user input at the parameter setting element is applied.

In some embodiments according to the present application, each of the actual carryover amount and the target carryover amount is showed in text, in a graph and or in a table.

In some embodiments according to the present application, the actual carryover amount and the target carryover amount are showed in a same graph or table.

In some embodiments according to the present application, the method further comprises: storing monitoring data of each sample; and displaying, on the user interface, the monitoring data of the one or more samples in response to a user request for one or more samples by the at least one next-activity element.

In some embodiments according to the present application, the target carryover amount comprises at least one of a target carryover count, a target carryover rate, a target carryover concentration and a target percentage of carryover concentration; and the actual carryover amount accordingly comprises at least one of an actual carryover count, an actual carryover rate, an actual carryover concentration and an actual percentage of carryover concentration.

In some embodiments according to the present application, the method further comprises displaying, on the user interface, control elements for starting, stopping, interrupting, cancelling, repeating the method or a step of the method.

In some embodiments according to the present application, the control elements comprise control buttons.

According to an aspect of the present application, there is provided a system for operating and monitoring the cleaning of a sample processing instrument, comprising: a fluid pipeline communicating fluid sources to a flow cell of the sample processing instrument; a pump arranged in the fluid pipeline; and a control device. The control device is configured to: direct a first sample through the flow cell in the sample processing instrument, wherein the first sample comprises first particles; process the first sample; control the pump to pump a cleaning agent through the fluid pipeline for cleaning the flow cell, and pump a monitoring solution through the fluid pipeline; measure a carryover amount in the cleaned flow cell, wherein the carryover amount comprises a measurement associated with an amount of the first particles remaining in a measurement region of the flow cell; compare the measured carryover amount against a predetermined target value, wherein the target value corresponds to a value indicative of a cleaning requirement; and determine, based on the comparison, whether the cleaning requirement is met.

In some embodiments according to the present application, the control device is further configured to: repeatedly clean the flow cell when it is determined that the cleaning requirement is not met; and stop a cleaning process when it is determined that the cleaning requirement has been met or when the number of cleaning reaches a maximum threshold.

In some embodiments according to the present application, the system further comprises a switching device, wherein the switching device is configured to enable the pump to be in fluid communication selectively with a sample needle fitted in the flow cell or a sample source of the fluid sources.

In some embodiments according to the present application, the switching device comprises a three-way valve including a first port connected to the pump, a second port connected to the sample needle and a third port connected to the sample source, and wherein the three-way valve is switched between a first position allowing the pump to communicate with the sample needle and a second position allowing the pump to communicate with the sample source.

In some embodiments according to the present application, the pump is communicated with at least two cleaning agents.

In some embodiments according to the present application, the at least two cleaning agents include sheath fluid.

In some embodiments according to the present application, the pump includes a first pump for pumping the sheath fluid and a second pump for selectively pumping the other cleaning agent and the monitoring solution.

In some embodiments according to the present application, the monitoring solution is water. In other embodiments, the monitoring solution is a buffer.

According to another aspect of the present application, there is provided a sample processing instrument comprising the cleaning system described above.

According to another aspect of the present application, there is provided a computer-readable medium on which a program is stored. The program is executed by a processor of a control device (e.g., on an associated personal computing device, on a dedicated device, etc.) to implement the method described above.

The above and other purposes, features and advantages of the present disclosure are fully understood through the detailed description and the drawings given for describing rather than limiting the present disclosure.

### BRIEF DESCRIPTION OF THE DRAWINGS

The features and advantages of one or more embodiments of the present disclosure will become more readily understood from the following description with reference to the accompanying drawings in which:

FIG. 1 is a functional block diagram of the sample processing instrument;

FIG. 2 is a schematic diagram of a part of a system according to an embodiment of the present application;

FIG. 3 is a schematic diagram showing the sampling process of the system of FIG. 2;

FIGS. 4 to 6 are schematic diagrams showing that the system of FIG. 2 performs cleaning with a cleaning agent other than the sheath liquid;

FIGS. 7 to 9 are schematic diagrams showing that the system of FIG. 2 performs cleaning with sheath fluid;

FIG. 10 is a schematic diagram of a part of a system according to another embodiment of the present application;

FIG. 11 is a schematic diagram of a part of a system according to yet another embodiment of the present application;

FIG. 12 is a schematic flowchart of a method for cleaning a sample processing instrument according to an embodiment of the present application;

FIG. 13 is a schematic flowchart of a method for cleaning a sample processing instrument according to another embodiment of the present application;

FIG. 14 is a schematic diagram of a user interface for monitoring cleaning of a sample processing instrument according to an embodiment of the present application;

FIG. 15 is a schematic diagram of an example of a menu of the user interface;

FIG. 16 is a schematic diagram of an example of a parameter setting element of the user interface;

FIG. 17 is a schematic diagram of an example of a setting-applicable-sample elements of the user interface;

FIGS. 18A to 18E are schematic diagrams of various examples of a monitoring element of the user interface;

FIG. 19 is a schematic diagram of an example of a historical data viewing element; and

FIG. 20 is a schematic diagram of a cleaning/monitoring user interface integrated in the sample processing user interface according to another embodiment of the present disclosure.

### DETAILED DESCRIPTION OF THE EMBODIMENTS

The present application is described in detail hereinafter by means of exemplary embodiments with reference to the accompanying drawings. In the several drawings, similar reference numerals indicate similar parts and components. The following detailed description of the present application is for explanation only and is by no means intended to limit the present application and the applications or usages thereof. The embodiments described in this specification are not exhaustive, but are only some of a number of possible embodiments. The exemplary embodiments may be implemented in many different forms, and should not be construed as limiting the scope of the present application. In some exemplary embodiments, well-known processes, well-known device structures, and well-known technologies may not be described in detail.

Before at least one embodiment of the present application is explained in detail, it is to be understood that the present application is not limited in its application to the details of construction and the arrangement of the components set forth in the following description or illustrated in the drawings. The invention is applicable to other embodiments that may be practiced or carried out in various ways as well as to combinations of the disclosed embodiments. In addition, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “controlling”, “processing”, “calculating”, “determining”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The sample processing instrument according to the present disclosure will be described by taking a flow cytometer as an example. Flow cytometers are used to detect particles in a sample to determine one or more characteristics of the particles. However, it should be understood that the sample processing instrument according to the present disclosure is not limited to a flow cytometer, and may be any other suitable instrument for processing biological samples or non-biological samples. In some embodiments, the sample processing instrument may be a cell or particle sorter.

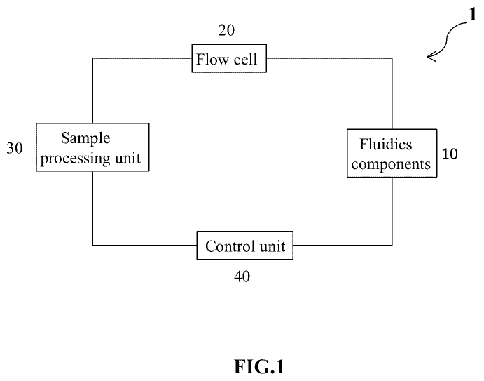

The sample processing instrument according to the present disclosure is suitable for automatically performing the cleaning process between processing different samples, for automatically performing the cleaning process using different cleaning agents, and for automatically performing the monitoring process of measuring the cleaning result after the cleaning process. The system may additionally automatically determine the next action according to the measurement result. Additionally, the system may provide an interface to a user to enable to user to easily operate and intuitively observe the monitoring and cleaning process. The main functional parts of the sample processing instrument 1 will be described below with reference to FIG. 1. The sample processed (for example, analyzed or sorted) by the sample processing instrument 1 may include biological particles such as exosomes or extracellular vesicles or non-biological particles such as beads. The disclosed system is optimized for detecting and measuring particles at the nano-level (e.g., nanoparticles, nanobeads, exosomes), but the disclosed system can also be used for larger particles.

FIG. 1 is a functional block diagram of the sample processing instrument 1. As shown in FIG. 1, the sample processing instrument 1 includes fluidics components 10, a flow cell 20, a sample processing unit 30 and a control unit 40.

The fluidics components 10 are configured to supply various fluids to the flow cell 20 and to discharge the fluid out of the flow cell 20. The fluids described herein may include samples to be analyzed, sorted or otherwise processed, sheath fluid, cleaning agents, waste fluids, and the like.

The fluidics components 10 may include various pumps, valves, pressure regulating devices, sensors, etc., for delivering fluid or discharging fluid.

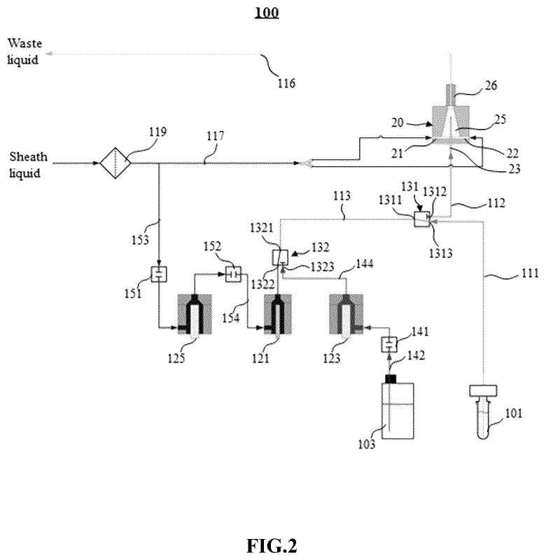

Various fluids, particularly samples and sheath fluid are delivered to the flow cell 20. Referring to FIG. 2, the flow cell 20 includes two opposite sheath ports 21 and 22, and the sheath fluid is delivered to the chamber 25 of the flow cell 20 through the sheath ports 21 and 22. The flow cell 20 further includes a sample needle 23 disposed therein, and the sample is transported into the chamber 25 through the sample needle 23. In the chamber 25, the sample is wrapped in sheath fluid and then flows through the cuvette 26 for processing. The cuvette 26 forms the processing area of the sample. For example, the optical detection device focuses the light beam in the processing area of the cuvette 26. In case that the particles in the sample pass through the processing area of the cuvette 26, the characteristics of the particles are determined by measuring the light scattered or emitted from the particles.

The sample processing unit 30 processes the sample wrapped in the sheath fluid flowing through the cuvette 26. For example, the sample processing unit 30 may measure characteristics of particles/cells in the sample and quantify the particles/cells having particular characteristics, and/or the sample processing unit 30 may sort particles/cells in the sample based on their characteristics. The sample processing unit 30 may include various optical devices, electrical devices, and/or mechanical devices according to the aim of sample processing.

The control unit 40 controls the operation of the entire sample processing instrument 1. The various functions, actions, or steps of the various systems, devices, components, or methods of the sample processing instrument according to the present application are controlled by the control unit 40. The control unit 40 will be described in detail below.

An example of fluidics components according to an embodiment of the present application will be described below with reference to FIGS. 2 to 9 showing a part of a system 100, which includes fluidics for controlling flow of different fluids. As described above, the fluidic system 100 is used to supply various fluids to the flow cell 20 and to discharge the fluid out of the flow cell 20. To this end, the fluidic system 100 includes fluid pipelines connecting various fluid sources to the flow cell 20.

These fluid sources may include a sample source 101, a sheath source (not shown), a waste reservoir, and other solution sources. The sample source 101 is used to supply samples. Generally, the sample source 101 includes multiple sample containers containing different samples, for example, a well plate, a test tube, and the like. The sheath fluid is stored in the sheath source. Sheath liquid is the matrix liquid that helps the sample flow to be detected normally, and may function to wrap around the sample flow and keep it in the center of the nozzle to ensure the accuracy of detection while preventing particles in the sample flow from approaching the nozzle wall and blocking the nozzle. In addition, the sheath fluid may also be used as a cleaning agent for cleaning the sample processing instrument (especially, the flow cell and the fluid pipelines). Other solution sources include a fluid container 103 storing other cleaning agents (for example, water or another special cleaning solution) rather than the sheath fluid, and a separate container (not shown) storing a monitoring solution (for example, water or a buffer) for measuring the cleaning result of the sample processing instrument. The waste reservoir is used to collect the waste liquid after sample processing and cleaning of the sample processing instrument.

Referring to FIG. 2, the fluid pipeline includes sample pipelines 111, 112 and 113 that communicate the sample source 101 to the sample needle 23, a sheath pipeline 117 for communicating a sheath source (not shown) to the sheath ports 21 and 22 of the flow cell 20; a waste pipeline 116 for communicating the flow cell 20 to a waste reservoir (not shown); sheath cleaning pipelines 153 and 154 for conveying sheath fluid for cleaning, and cleaning agent pipelines 142 and 144 for conveying a cleaning agent for cleaning.

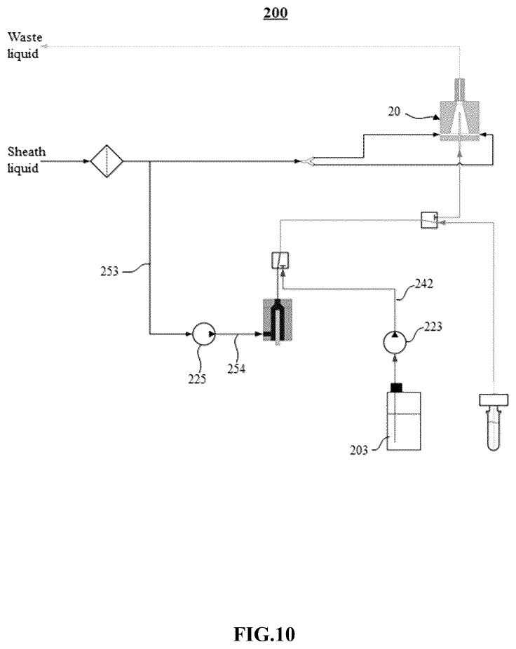

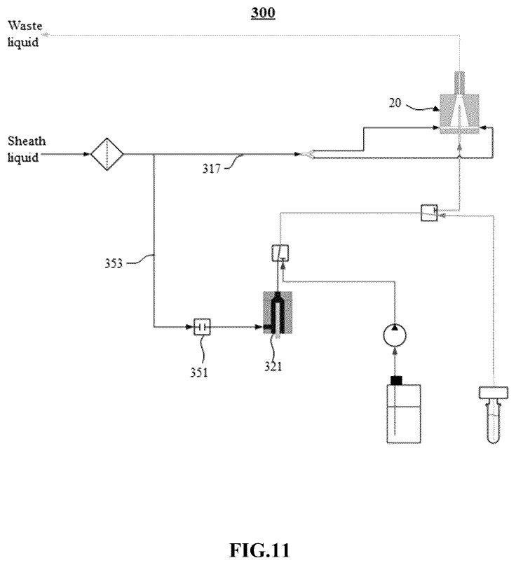

Various pumps for pumping various fluids may be provided in the fluid pipeline. In the example shown in FIG. 2, there is a sample pump 121 for pumping samples, a sheath pump 125 for pumping sheath liquid for cleaning, and a cleaning pump 123 for pumping a cleaning agent. In the example of FIG. 2, the sample pump 121, the sheath pump 125, and the cleaning pump 123 are all piston pumps. However, it should be understood that the systems disclosed in the present application are not limited to the specific examples shown in the drawings, as long as it can realize the functions described herein. For example, the type of the pump may be varied. In another embodiment shown in FIG. 10, the sheath pump 125 and the cleaning pump 123 may be other types of pumps such as peristaltic pumps. Similarly, the sample pump 121 may also adopt any other suitable type of pump, for example, a peristaltic pump. In some embodiments, the number of pumps may be changed. In the example shown in FIG. 11, the sheath pump is omitted.

Various switching devices may be provided in the fluid pipeline, for example, for switching the flowing direction of the fluid or for controlling the on-off state of the fluid. The switching device may include various types of valves. As shown in FIG. 2, the switching device includes three-way valves 131 and 132 and on-off valves 141, 151 and 152.

The three-way valve 132 is configured to selectively communicate the sample pipelines 111 to 113 with different pumps (for example, the sample pump 121 or the cleaning pump 123) to suck or pump different fluids (for example, the sample or the cleaning agent) to the flow cell 20 or the sample source 101. In the example of FIG. 2, the three-way valve 132 includes a first port 1321 connected to the sample pipeline 113, a second port 1322 connected to the sample pump 121, and a third port 1323 connected to the cleaning pump 123. In case that the first port 1321 is switched to communicate with the second port 1322, the sample pump 121 is allowed to suck a sample from the sample source 101 when the sample pipeline 113 is connected to the sample pipeline 111 or pump a fluid (e.g., a sample or sheath fluid) to the flow cell 20 when the sample pipeline 113 is connected to the sample pipeline 112. That is, the system may allow the sample pump 121 to suck a sample from the sample source 101 by switching the valve 132 to connect the sample pump 121 to the sample pipeline 113 and by switching the valve 131 to connect the sample pipeline 113 to the sample pipeline 111 (the sample or sheath fluid may alternatively be sent to the flow cell 20 by switching the valve 131 to connect the sample pipeline 113 to the sample pipeline 112). The system may allow the cleaning pump 123 to suck the cleaning agent from the fluid container 103 and pump it to the flow cell 20 by switching the valve 132 to connect the cleaning pipeline 144 to the sample pipeline 113 and by switching the valve 131 to connect the sample pipeline 113 to the sample pipeline 112 (the cleaning agent may alternatively be sent to the sample source 101 by switching the valve 131 to connect the sample pipeline 113 to the sample pipeline 111).

The three-way valve 131 is configured to selectively communicate a pump (e.g., the sample pump 121 or the cleaning pump 123) with the sample source 101 or the flow cell 20 to selectively suck or pump fluid (e.g., the sample or the cleaning agent) to the flow cell 20 or the sample source 101. In the example of FIG. 2, the three-way valve 131 is provided between the sample pipelines 111, 112 and 113 for selectively communicating the sample pipeline 113 with the sample pipeline 111 or the sample pipeline 112. The three-way valve 131 has a first port 1311 connected to the sample pump 121 or the cleaning pump 123 via the three-way valve 132, a second port 1312 connected to the sample needle 23, and a third port 1313 connected to the sample source 101. The system may allow the fluid in the sample pipeline 113 (for example, the sample pumped by the sample pump 121 or the cleaning agent pumped by the cleaning pump 123) to be conveyed into the flow cell 20 by switching the valve 131 to connect the sample pipeline 113 to the sample pipeline 112, or alternatively allow fluid to be sucked from/pump into the sample source 101 by switching the valve 131 to connect the sample pipeline 113 to the sample pipeline 111.

By the three-way valves 131 and 132, it is possible to selectively pump the sample to the flow cell 20 to, for example, analyze the sample, or pump the cleaning agent to the sample source 101 or the flow cell 20 to clean the sample pipelines 111 to 113 or the flow cell 20.

The cleaning pump 123 is connected to the third port 1323 of the three-way valve 132 via a cleaning agent pipeline 144, and is connected to the fluid container 103 via a cleaning agent pipeline 142. An on-off valve 141 may be provided in the cleaning agent pipeline 142 to control the on-off state of the cleaning agent pipeline 142. In case of sucking the cleaning agent, the on-off valve 141 is in a closed state to allow communication of the cleaning agent pipeline 142. In case of no need to suck the cleaning agent, the on-off valve 141 is in an open state to interrupt the communication of the cleaning agent pipeline 142.

The sheath pump 125 is arranged between the sheath pipeline 117 connected to the sheath source and the sample pump 121 to deliver the sheath fluid to the sample source 101 or the flow cell 20 via the sample pump 121, so as to clean the sample pipelines 111-113 or the flow cell 20 with the sheath fluid. The sheath pump 125 is connected to the sheath pipeline 117 (or the sheath source) via the sheath cleaning pipeline 153, and is connected to the sample pump 121 via the sheath cleaning pipeline 154. An on-off valve 151 may be provided in the sheath cleaning pipeline 153 to control the on-off state of the sheath cleaning pipeline 153. In case that the sheath fluid is sucked for cleaning, the on-off valve 151 is in a closed (i.e., on) state to allow communication of the sheath cleaning pipeline 153. In case of no need to suck the sheath fluid, the on-off valve 151 is in an open (i.e., off) state to interrupt the communication of the sheath cleaning pipeline 153. Furthermore, an on-off valve 152 may be provided in the sheath cleaning pipeline 154 to control the on-off state of the sheath cleaning pipeline 154. In case of pumping the sheath fluid, the on-off valve 152 is in a closed (i.e., on) state to allow the communication of the sheath cleaning pipeline 154. In case of no need to pump the sheath fluid, the on-off valve 152 is in an open (i.e., off) state to interrupt the communication of the sheath cleaning pipeline 154.

It should be understood that the system according to the present application is not limited to the specific example shown in FIG. 2, but may be changed according to actual requirements. For example, in the system 200 shown in FIG. 10, the sheath pump 225 and the cleaning pump 223 may be peristaltic pumps, and accordingly, on-off valves may be omitted in the sheath cleaning pipelines 253 and 254 and the cleaning agent pipeline 142. In the system 300 shown in FIG. 11, the sheath pump is omitted, and instead, only an on-off valve 351 is provided in the sheath cleaning pipeline 353 between the sheath pipeline 317 (or the sheath source) and the sample pump 321. It should be understood that the system according to the present application is not limited to having the components described above. For example, it may also have a filter (for example, a filter 119 for filtering sheath fluid as shown in FIG. 2), a sensor for sensing temperature or pressure, a regulator for adjusting temperature or pressure, and the like.

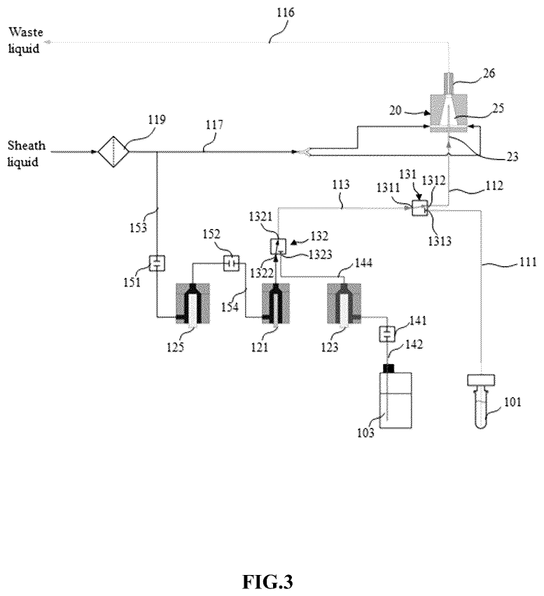

The process of conveying a sample through the fluidic system 100 during sample processing will be described below with reference to FIGS. 2 and 3.

As shown in FIG. 2, when a sample is to be processed, the three-way valve 132 is switched such that the sample pump 121 is connected to the sample pipeline 113, and the three-way valve 131 is switched such that the sample pipeline 113 is connected to the sample pipeline 111, whereby the sample is sucked from the sample source 101 into the sample pipeline 113 by the sample pump 121 (for example, the piston of the sample pump 121 moves downward).

Then, as shown in FIG. 3, the three-way valve 131 is switched such that the sample pipeline 113 is connected to the sample pipeline 112, and the sample in the sample pipeline 113 is pumped into the flow cell 20 by the sample pump 121 (for example, the piston of the sample pump 121 moves upward) for processing (for example, detection or sorting, etc.).

During the sample processing, the sample pump 121 is always connected to the sample pipeline 113, and the three-way valve 131 is repeatedly switched between the second port 1312 and the third port 1313 to repeatedly perform the processes of sucking and pumping samples until the sample processing is finished.

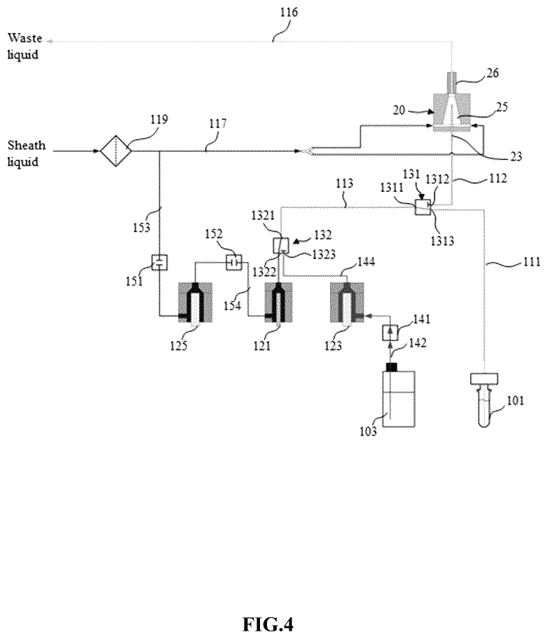

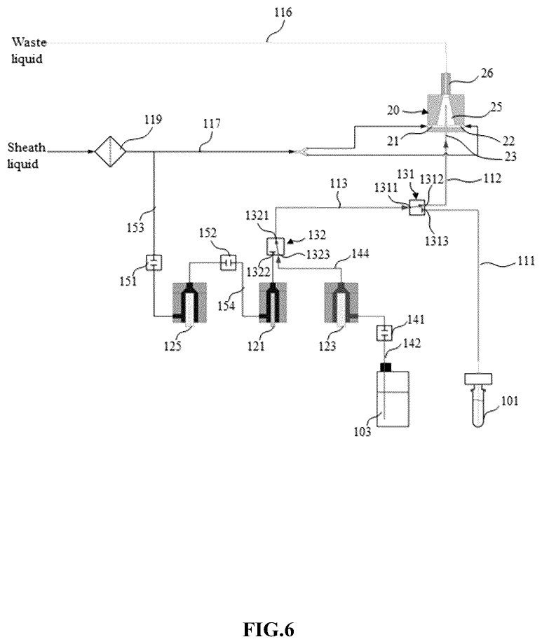

The process of cleaning the sample pipelines 111 to 113 and the flow cell 20 by the fluidic system 100 using the cleaning agent will be described below with reference to FIGS. 4 and 6.

As shown in FIG. 4, when the sample processing instrument is to be cleaned with the cleaning agent, the on-off valve 141 is closed to communicate the cleaning agent pipeline 142, thereby allowing the cleaning pump 123 to suck the cleaning agent from the fluid container 103.

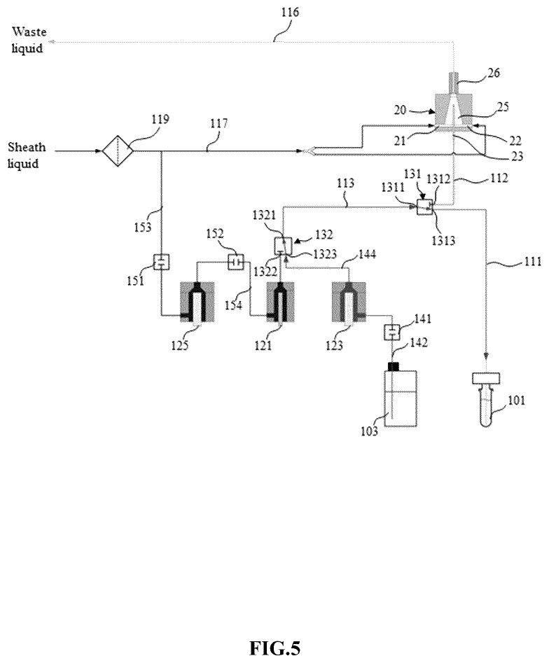

As shown in FIG. 5, the on-off valve 141 is switched to an open state, and the three-way valve 132 is switched such that the cleaning agent pipeline 144 is connected to the sample pipeline 113 to pump the cleaning agent into the sample pipeline 113. At this moment, the three-way valve 131 may be in a state where the sample pipeline 113 is connected to either of the sample pipeline 112 and the sample pipeline 111.

In the case that the sample pipeline 113 is connected to the sample pipeline 111 as shown in FIG. 5, the cleaning agent is pumped through the sample pipeline 111, thereby cleaning the sample pipelines 113 and 111. Next, the on-off valve 141 is repeatedly put in a closed state or an open state to suck or pump the cleaning agent until the sample pipeline 111 is cleaned.

In the case that the sample pipeline 113 is connected to the sample pipeline 112 as shown in FIG. 6, the cleaning agent is pumped through the sample pipeline 112 and the flow cell 20, thereby cleaning the sample pipelines 113 and 112 and the flow cell 20. Next, the on-off valve 141 is repeatedly in the closed or open state to suck or pump the cleaning agent until the sample pipeline 112 and the flow cell 20 are cleaned.

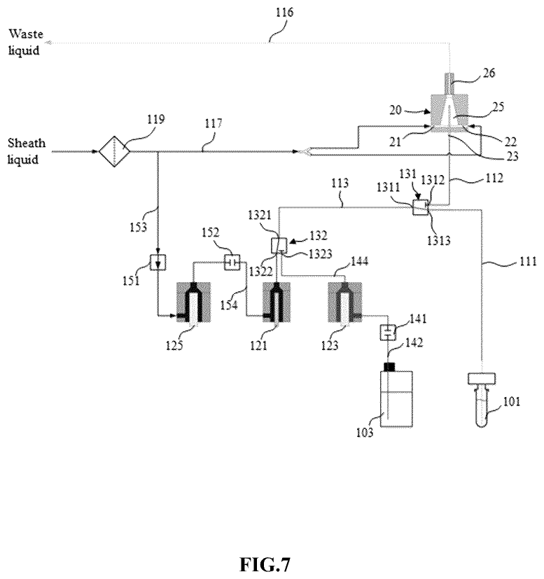

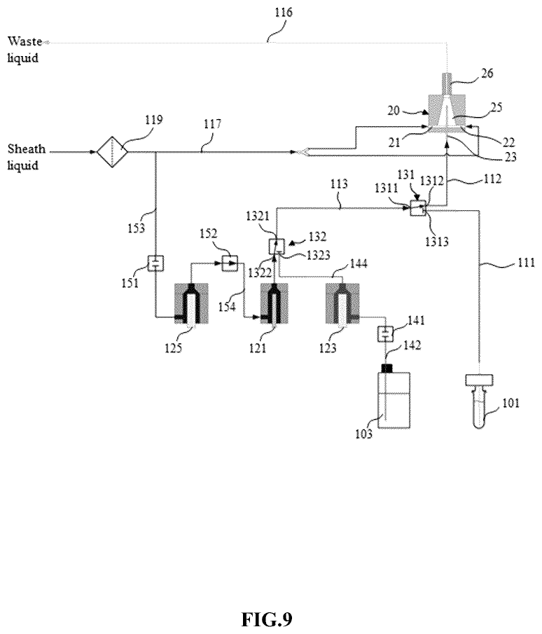

The process of cleaning the sample pipelines 111 to 113 and the flow cell 20 by the fluidic system 100 using the sheath liquid will be described below with reference to FIGS. 7 and 9.

As shown in FIG. 7, when the sample processing instrument is to be cleaned with sheath liquid, the on-off valve 151 is closed to allow communication of the sheath cleaning pipeline 153, thereby allowing the sheath pump 125 to suck the sheath liquid from a sheath source (not shown).

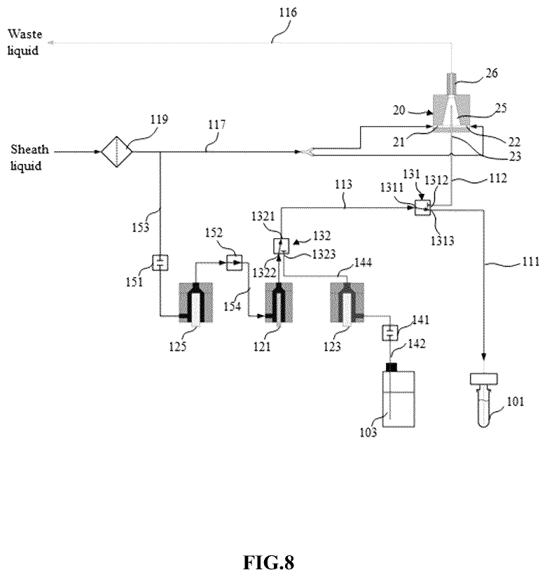

Then, as shown in FIG. 8, the on-off valve 151 is put in an open state, and the on-off valve 152 is put in a closed state and the three-way valve 132 is switched such that the first port 1321 communicates with the second port 1322 to pump the sheath fluid into the sample pipeline 113 via the sample pump 121. The three-way valve 131 may be in a state where the sample pipeline 113 is connected to either of the sample pipeline 112 and the sample pipeline 111.

In the case that the sample pipeline 113 is connected to the sample pipeline 111 as shown in FIG. 8, the sheath fluid is pumped through the sample pipeline 111, thereby cleaning the sample pipelines 113 and 111. Next, the on-off valve 151 and the on-off valve 152 are alternately in a closed state or an open state to suck or pump the sheath fluid until the sample pipeline is cleaned.

In the case that the sample pipeline 113 is connected to the sample pipeline 112 as shown in FIG. 9, the sheath fluid is pumped through the sample pipeline 112 and the flow cell 20, thereby cleaning the sample pipelines 113 and 112 and the flow cell 20. Next, the on-off valve 151 and the on-off valve 152 are alternately in a closed state or an open state to suck or pump the sheath fluid until the sample pipeline and the flow cell 20 are cleaned.

In addition to the sample processing and cleaning processes described above, the system may also be used for monitoring the cleaning of the sample processing instrument.

In some embodiments, sample source 101 may be filled with a monitoring solution (e.g., water, a buffer), instead of a sample, in between analyses of two different samples. For example, a first sample in a sample source 101 may be analyzed by the system 100, the system 100 may be cleaned with a cleaning agent from the fluid container 103, and then sample source 101 may be switched for a different sample source 101 filled with a monitoring solution for monitoring the flow cell 20 for the presence of carryover. In some cases, the monitoring solution and the cleaning agent may be the same fluid, for example, water.

In some embodiments, the cleaning agent may be the monitoring solution, in which case the fluid container 103 may be used as the source of the monitoring solution as well as the cleaning agent. In this case, the process of feeding the monitoring solution through the flow cell 20 during the monitoring process may be similar to the process of feeding the cleaning agent through the flow cell 20 during the cleaning process.

In some embodiments, a separate fluid container (i.e., a container other than the sample source 101 and the fluid container 103) may be provided to contain the monitoring solution. In this case, the same pump as other fluids or an additional pump may be used to pump the monitoring solution through the flow cell 20. The fluid pipeline for the monitoring solution may be integrated into other fluid pipelines like the sheath cleaning pipeline, or may be an independent fluid pipeline from the fluid container containing the monitoring solution to the flow cell 20. Similarly, the sheath cleaning pipeline may also be formed as an independent fluid pipeline from the sheath source to the flow cell 20 and the sample pipeline, that is, it does not pass through the sample pump 121.

As described above, the structure of the disclosed systems and their fluidics components are not limited to the specific examples described and shown above, but can be varied as long as it can realize automatic cleaning/monitoring processes or automatic cleaning process with different cleaning agents. Furthermore, since the structure of the disclosed systems can be changed, the operation method of the disclosed systems can be changed accordingly.

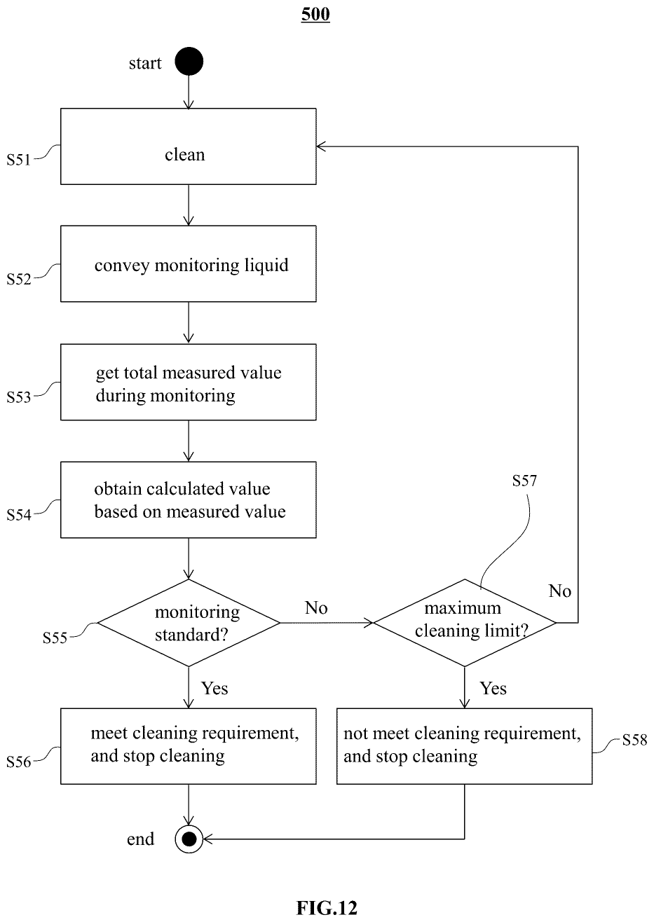

Hereinafter, a method 500 for cleaning and monitoring the sample processing instrument 1 by means of the above-mentioned disclosed systems according to an embodiment of the present application will be described with reference to FIG. 12.

The sample processing instrument 1 firstly feeds a first sample containing first particles through the flow cell 20 via the pipelines of the system, and processes the first sample, for example, detecting or sorting the first particles. The first particles are, for example, biological nanoparticles. After the first sample has been processed, there may be a need to process a second sample. For accurate results, the flow cell 20 and one or more pipelines of the system may need to be washed in between successive samples to prevent particles from the first sample from affecting the results of processing the second sample. It is generally difficult to remove these leftover particles, referred to herein as carryover, especially when the particles are of a small size. Therefore, in order to ensure the accurate processing of the second sample, the sample processing instrument 1 (especially, the sample pipeline and the flow cell) must be adequately cleaned.

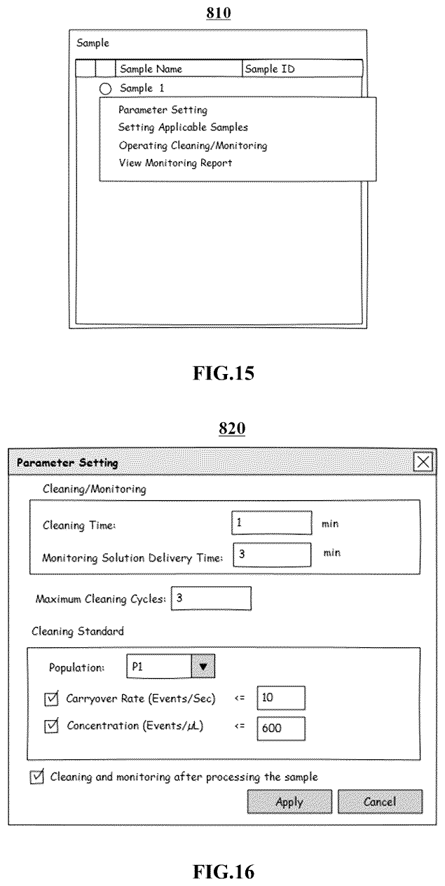

According to the first sample (especially, the first particle), a suitable cleaning agent (e.g., sheath fluid, water and/or any other suitable cleaning solution), cleaning parameters (e.g., duration of one cleaning cycle, number of cleaning cycles, maximum number of cleaning cycles, etc.), monitoring solution (e.g., water) and/or monitoring parameters can be selected or set. The monitoring parameters may include parameters associated with the monitored solution (e.g., delivery time or volume, etc.), populations associated with monitored particles or monitoring parameters (e.g., monitoring criteria indicating that cleaning requirements are met). The monitoring standard may be embodied in various forms, for example, the target carryover count within a predetermined time, the target carryover concentration/concentration percentage, the target carryover rate (number/second), and so on. Example settings of cleaning parameters and monitoring parameters and criteria may be seen in FIG. 16.

Then, at step S51, the sample processing instrument 1 is cleaned by the selected cleaning agent according to the set cleaning parameters. In a cleaning cycle, the selected cleaning agent may be one, two or more. Correspondingly, cleaning parameters may be set for each cleaning agent. The cleaning parameters may be determined based on experimental data, historical data or experimental data. After a cleaning cycle or a predetermined number of cleaning cycles, proceed to step S52.

At step S52, the monitoring solution is pumped through the flow cell 20 by the fluidics components. The sample processing instrument 1 then analyzes the flow cell 20 including the monitoring solution during the monitoring period (see step S53).

At step S53, a measurement value related to the carryover or the monitoring solution during the monitoring period is obtained, for example, the amount of the carryover (first particle) and/or the flow rate of the monitoring solution. The flow rate of the monitoring solution may be measured by one or more sensors. For example, for a sample processing instrument 1 that is a flow cytometer, the measurement may be performed by measuring light scattered from the flow cell 20 in response to one or more laser beams directed at the flow cell 20. In this example, the carryover (first particles remaining in the flow cell 20) may be counted by, for example, an optical detection system based on the detected light scattered or emitted from the particles. In the same monitoring time, the lower the amount of carryover (e.g., a count or approximate count of the number of carryover particles remaining in the flow cell 20 during the monitoring period), the better the cleaning results. Of course, as the monitoring time is longer, the amount of carryover detected is greater. If the measured value is not sufficient to indicate the cleaning level, proceed to step S54.

At step S54, based on the measured value obtained at step S53, a value that accurately indicates the cleaning level may be calculated. For example, the value may be a carryover rate (number/second) (carryover particles detected during monitoring divided by monitoring time), a carryover concentration (number/microliter) (number of carryover particles detected during monitoring divided by volume of monitoring solution), or a carryover concentration percentage (ratio of carryover concentration to concentration of the first particle in the first sample). It should be understood that, if the measurement value obtained at step S53 is sufficient to indicate the cleaning level, step S54 can be omitted.

At step S55, the calculated value at step S54 or the measured value at step S53 (for example, if step S54 is omitted) may be compared with a target value as the monitoring standard. In the case that the measured or calculated value (actual value) is less than or equal to the target value, it indicates that the cleaning requirement has been met, and proceed to step S56. In the case that the measured or calculated value (actual value) is greater than the target value, it indicates that the cleaning requirement has not been met, and then proceed to step S57. In some embodiments, the target value may be based on the first sample, the second sample, or the type of processing that is occurring. For example, different samples or different sample processing/analyses may have different target values.

At step S56, since the cleaning requirement has been met, the cleaning process is stopped and ready for processing the next sample. Optionally, at step S56, the user may be notified that the cleaning requirement has been met. The second sample may be then automatically transported through the flow cell and processed at the flow cell.

At step S57, it is further determined whether the maximum cleaning limit has been reached, for example, the set maximum cleaning duration limit (e.g., a maximum limit on the total amount of time spent in one or more cleaning cycles) or the maximum cleaning cycle number limit (e.g., a maximum limit placed on the number of cleaning cycles performed). In some embodiments, the maximum cleaning limit may be set by the user. In some embodiments, the maximum cleaning limit may be based on the first sample, the second sample, or the type of processing that is occurring. For example, different samples or different sample processing/analyses may have different maximum cleaning limits. If the maximum cleaning limit is not reached, return to step S51 and continue the cleaning process until the cleaning requirement is met or the maximum cleaning limit is reached. If the maximum cleaning limit is reached, proceed to step S58.

At step S58, the cleaning process is stopped. Optionally, at step S58, a message or warning may be issued to the user, so that the user may take appropriate measures, such as troubleshooting.

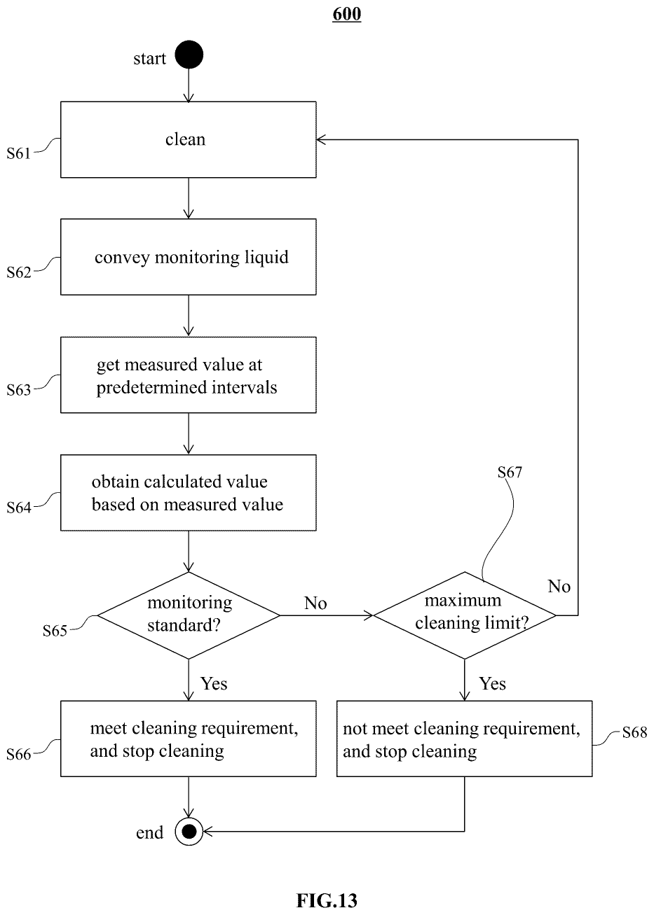

FIG. 13 is a schematic flowchart of a method 600 for cleaning a sample processing instrument according to another embodiment of the present application. Steps S61, S62, S64 to S68 of method 600 are the same as steps S51, S52, S54 to S58 of method 500, and therefore are not described in detail. The method 600 differs from the method 500 in step S63. The total measurement value during the monitoring period is acquired at step S53 of the method 500, whereas the measurement value is acquired at a predetermined interval at step S63 of the method 600. The predetermined interval here includes a continuous predetermined interval and a superimposed predetermined interval. A continuous predetermined interval means, assuming that the predetermined interval is 5 seconds, to obtain a measured value from 0 to the 5th second, a measured value from the 5th to the 10th second, a measured value from the 10th to 15th second, and so on, for example. A superimposed predetermined interval means, assuming that the predetermined interval is 5 seconds, to obtain a measured value from 0 to the 5th second, a measured value from 1st second to the 6th second, and a measured value from 2nd second to the 7th second, and so on, for example. Accordingly, the calculated value within the predetermined interval is obtained at step S64.

In the method 600, once it is found that the cleaning requirement has been met, the monitoring process may be stopped immediately. Therefore, compared with the method 500, the method 600 enables the user to learn the information that the cleaning requirement has been met more quickly.

It should be understood that the method according to the present application is not limited to the above-mentioned methods 500 and 600, but may be changed according to requirements. For example, the method of obtaining the measured value may be changed, and the set parameters may be changed. For example, in step S55 or S65, both the measured value and the calculated value can be used to determine whether the cleaning requirement has been met. Moreover, steps of the method may not necessarily be executed in the described order, but can be interchanged in order or executed at the same time without contradiction. In addition, the method may omit a certain step or add additional steps.

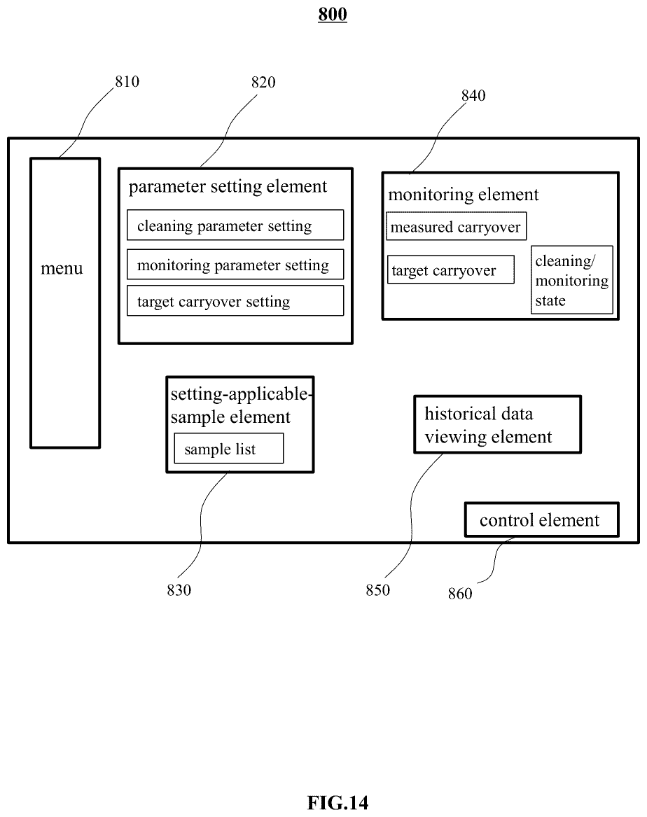

In order to facilitate user operations and obtain information, the method of the present application may be carried out with a user interface. The user interface according to the present application will be described below with reference to FIGS. 14 to 20.

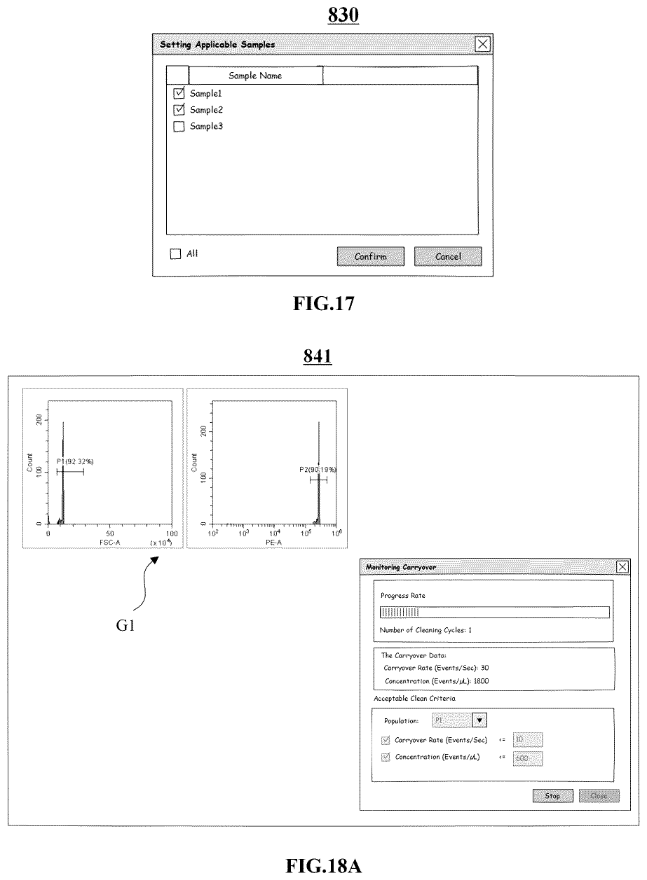

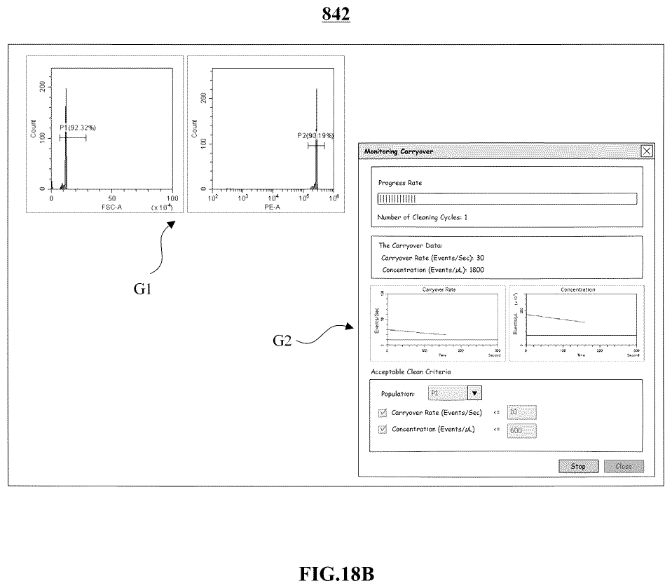

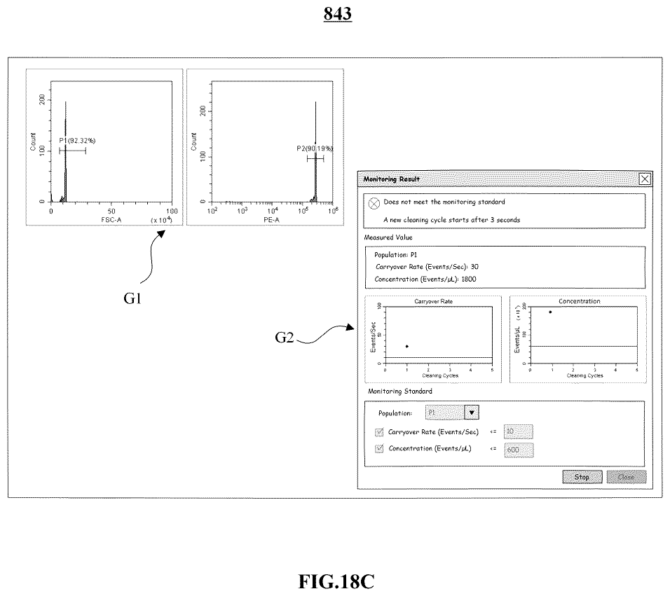

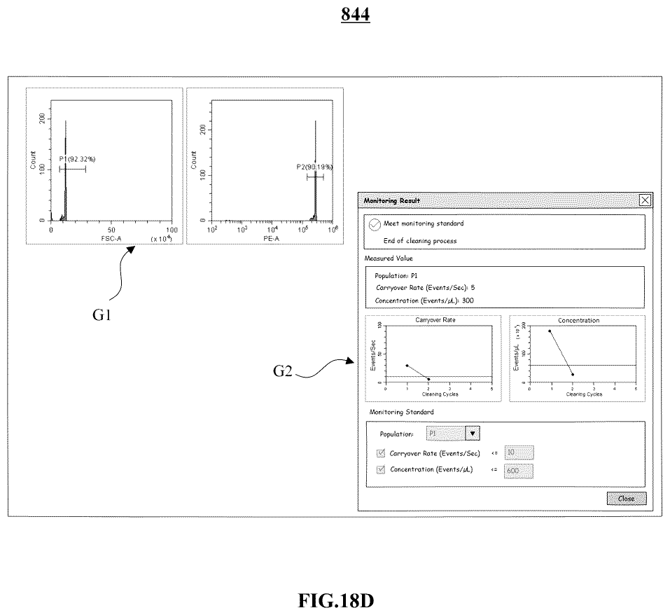

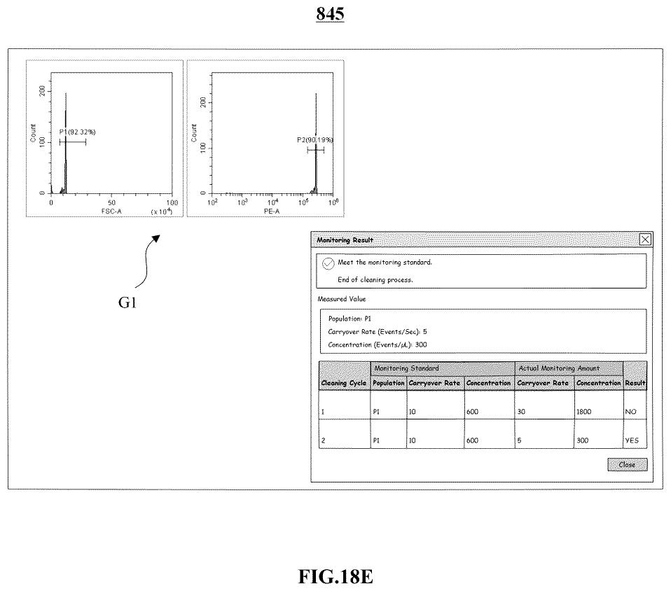

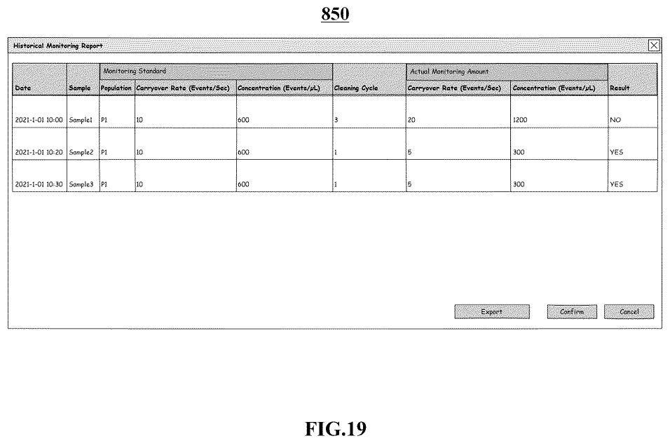

Referring to FIG. 14, the user interface 800 may include a menu 810, a parameter setting element 820, a monitoring element 840, a setting-applicable-sample element 830, a historical data viewing element 850 and a control element 860. The menu 810 may include one or more next-activity element that enable the user to interact with the sample processing instrument by configuring the processing of samples and the cleaning of the sample processing instrument or monitoring such processing or cleaning. The next-activity element will be described in detail below with reference to FIG. 15. The parameter setting element 820, the monitoring element 840, the setting-applicable-sample element 830 and the historical data viewing element 850 may be displayed on the user interface in response to the selection or operation of the corresponding next-activity element of the menu 810, so that the user can input information or information is displayed to the user. The parameter setting element 820 is used to receive user input related to cleaning, monitoring and carryover (which will be described in detail below with reference to FIG. 16). The monitoring element 840 is configured to display information related to cleaning or monitoring status, monitoring data, monitoring results, monitoring standards, etc., to the user (which will be described in detail below with reference to FIGS. 18A to 18E). The setting-applicable-sample element 830 includes samples to be monitored, and the user may select samples to which the settings at the parameter setting element 820 are applied, so that the sample processing instrument may automatically and continuously process multiple samples (which will be described in detail below with reference to FIG. 17). The historical data viewing element 850 may retrieve or view historical monitoring data according to user request (which will be described in detail below with reference to FIG. 19). The control element 860 allows the user to control various elements displayed on the user interface or display contents of various elements.

As shown in FIG. 14, the menu 810, the parameter setting element 820, the setting-applicable-sample element 830, the monitoring element 840, the historical data viewing element 850 and the control element 860 may be displayed simultaneously on one screen, for example, within the corresponding boxes. It should be understood that the user interface according to the present application should not be limited to the specific example shown in FIG. 14, but may be changed as required. In some embodiments, any subset of these interface elements may be displayed simultaneously on the user interface. For example, in some cases, only the menu 810 and the parameter setting element 820 may be displayed simultaneously on the user interface 800. In some embodiments, the interface elements displayed on the user interface may be selected based on a user input. For example, the user may select the setting-applicable-sample element 830, and in response, the user interface may show an enlarged setting-applicable-sample element 830 and none (or only a subset) of the other interface elements. For example, the historical data viewing element 850 is optional. Furthermore, the layout of various elements on the user interface may be changed. The content and display form of each element may also be changed as required.

Hereinafter, the elements of the user interface will be described with reference to specific examples shown in the figures. These examples are for illustrative purposes only, and are not a limitation to the present application.

FIG. 15 shows an example of the menu 810. As shown in FIG. 15, the menu 810 may display a number of different next-activity elements, including “parameter settings”, “setting applicable samples”, “operate cleaning/monitoring”, and “view monitoring report”.

The menu 810 allows the user to select among the different next-activity elements. For example, the user may select the next-activity element of the “parameter setting” of the menu 810. In response, the parameter setting element 820 may be displayed on the user interface for the user to input. In some examples, the parameter setting element may be shown in the form of an independent window (for example, a pop-up window), which may also be referred to as an operation window or a setting window herein. The parameter setting element may include the settings of cleaning parameters, the settings of monitoring parameters, and the settings of the target carryover amount.

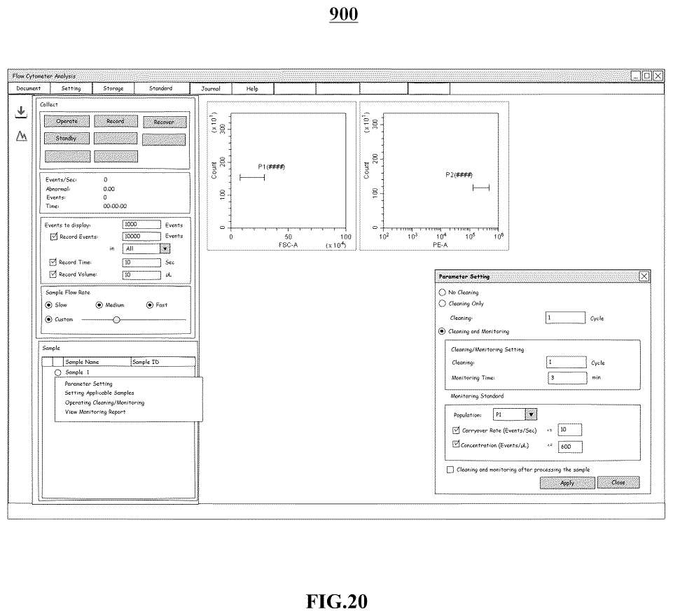

FIG. 16 shows an example of a parameter setting element 820. As shown in FIG. 16, the setting of the cleaning parameters includes the cleaning time of a cleaning cycle and the maximum number of cleaning cycles. The setting of monitoring parameters includes the delivery time of the monitoring solution. In some examples, the target carryover amount may be a target count (or approximate count) of carryover particles, a target carryover rate (a quantification of carryover particles acceptable/desired to be within the flow cell over a time period (e.g., per second) as a monitoring solution is to be flowed through the flow channel), a target carryover concentration (expressing a desired concentration of the carryover particles in the volume of a monitoring solution that is to be within the flow cell), etc. In addition, in the example of FIG. 16, the setting of the population to which the sample to be monitored belongs is also included. It should be understood that the parameter settings may be changed according to requirements, and are not limited to the specific examples shown in the figure. For example, in the parameter setting element, options for operating the program (for example, “no cleaning”, “cleaning only”, “cleaning and monitoring” as shown in FIG. 20) may also be set for the user to choose. In the example shown in FIG. 16, the user inputs and selects in the form of a text field or a drop-down list. However, the settings may also be input in any other suitable way, for example, a dialog box, a radio button, a slider element, etc.

After the user clicks the next-activity element of “setting applicable sample” of the menu 810, a setting-applicable-sample element 830 is displayed on the user interface. FIG. 17 shows an example of a setting-applicable-sample element 830. As shown in FIG. 17, all the samples to be monitored are shown in the setting-applicable-sample element 830. Samples may be distinguished by the name of the container that contains the sample. There are radio buttons in front of each sample for users to choose. The setting-applicable-sample element 830 allows users to have different acceptable cleaning standards following the processing of different samples (e.g., samples that are to be run successively) by, for example, letting the user set different target carryover amounts for the different samples (e.g., via the example element 820 shown in FIG. 16, as described in further detail above). For example, a user may have three samples to run successively (e.g., Sample 1, followed by Sample 2, followed by Sample 3) through the sample processing instrument. In this example, as illustrated in FIG. 17, a user may select Sample 1 and Sample 2 by checking their respective boxes in the element 830 and set cleaning standards by setting desired target carryover amounts (e.g., via the element 820, setting a target carryover rate and a target concentration) for both Sample 1 and Sample 2. The user may then select Sample 3, by checking its respective box (while the boxes for Sample 1 and Sample 2 are unchecked) and set cleaning standard for Sample 3 in a similar manner. As another example, the user may set cleaning standards for one sample (e.g., Sample 1) and then copy those cleaning standards to one or more different samples (e.g., Sample 2) for a similar effect. In some examples, the sample processing instrument may automatically process each of the different samples successively and automatically based on the pre-set cleaning standards selected for each of the different samples. For example, Samples 1 to 3 may be processed automatically and successively, with desired cleaning cycles performed according to their pre-set cleaning standards, thereby improving the efficiency of the sample processing instrument. That is, the user may not need to manually monitor and submit manual inputs during the processing of these different samples. It should be understood that the display of the sample is not limited to the specific example shown in FIG. 17, but may be shown in any other suitable manner or for the user to select or input.

After the user clicks the next-activity element of “run Cleaning/Monitoring” in the menu 810, the cleaning/monitoring process is started according to the settings or selections in FIG. 16 and FIG. 17. The monitoring element 840 is displayed on the user interface. The monitoring element 840 may display the cleaning/monitoring state, the measured carryover amount, the target carryover amount, and the like to the user.

The monitoring element 840 may be shown in one or more windows or modules according to various stages of cleaning/monitoring. The content related to the entire monitoring period may always be displayed on the user interface, and the content related to each stage of cleaning/monitoring may be displayed in separate windows (for example, pop-up windows). It should be understood that the display content and display form of the monitoring element 840 are not limited to the specific examples described herein or shown in the figures, but may be changed. For example, the state of the cleaning/monitoring process may be displayed in a separate state window, or the final result of the monitoring may be displayed in a separate browse window.

FIGS. 18A to 18E show various examples of monitoring elements 840. The examples of FIGS. 18A to 18E are different in the content displayed and the form of the carryover display according to the various stages of the method.

FIG. 18A shows a monitoring element 841. In the monitoring element 841, the state of the cleaning process includes the cleaning progress and the number of cleaning cycles. The carryover measurement data during the monitoring process represents the carryover data measured during the entire monitoring process, which is shown in the form of a histogram G1 in FIG. 18A, where the abscissa represents the intensity of signal of carryovers (e.g., signal of light), and the ordinate represents the count of carryovers (particles). The histogram G1 shows the measurement data of the entire monitoring process, so it can always be displayed on the user interface, such as the upper left of FIG. 18A. In this histogram G1, the longer the monitoring time, the larger the count of carryovers (particles). It should be understood that, as required, the measurement data may be displayed in any other suitable graphs, for example, scatter dot plots, density plots, pseudocolor plots, grayscale plots, and/or contour plots. It should be understood that the measurement data of the carryover may also be shown in any other suitable form besides the graph. In some cases, the measured carryover data may be used to determine whether a desired cleaning level has been achieved (e.g., from a determination that the measured carryover is below a desired threshold). In some examples, the measured carryover amount may be expressed in terms of, for example, a count or estimated count of carryover particles present in the flow cell, a carryover rate (a quantification of the carryover particles as detected within the flow cell over a time period (e.g., per second) as the monitoring solution is flowed through the flow channel), and/or concentration of carryover (expressing the concentration of the carryover particles in the volume of the monitoring solution that is within the flow cell). In some examples, the measured carryover amount may be a derived value that is only based on the carryover data measured by the system (e.g., a value derived by applying one or more formulae or functions to the measured carryover data). The measured carryover amount is shown in text form in FIG. 18A, as carryover rate (detection of carryover particles per second as the monitoring solution is flowed through the flow channel) and concentration of carryover. In FIG. 18A, the cleaning/monitoring state, the measured carryover amount, and the target carryover amount are displayed in separate pop-up windows.

FIG. 18B shows a monitoring element 842. The difference between the monitoring element 842 of FIG. 18B and the monitoring element of FIG. 18A is that the measured carryover amount and the set target carryover amount are also shown in the form of the portion of FIG. 18B labeled as G2. Through the portion G2, it can be intuitively seen whether the cleaning level meets the requirements. In FIG. 18B, the measured carryover amount is above the target carryover amount, so the cleaning standard has not yet been reached.

FIG. 18C shows a monitoring element 843. The monitoring element 843 of FIG. 18C is different from the monitoring element 842 of FIG. 18B in that it also shows the monitoring result, for example, the monitoring result after a cleaning cycle. Specifically, in FIG. 18C, the user is provided with information indicating that the monitoring result is not met, and a new cleaning cycle may start after 3 seconds.

FIG. 18D shows a monitoring element 844. The difference between the monitoring element 844 of FIG. 18D and the monitoring element 843 of FIG. 18C is that the monitoring result indicates that the cleaning standard has been met.

FIG. 18E shows a monitoring element 845. The difference between the monitoring element 845 of FIG. 18E and the monitoring element 844 of FIG. 18D is that the measured carryover amount and the set target carryover amount are shown in the form of a table. The measured carryover amount and the set target carryover amount are displayed in the same table, allowing the user to intuitively determine whether the cleaning standard has been met.

It should be understood that the measured actual carryover amount and target carryover amount are not limited to being displayed in texts (as shown in FIG. 18A), graphs (as shown in FIG. 18B to FIG. 18D) and tables (as shown in FIG. 18E), but can be shown in any other suitable form.

After the user clicks the next-activity element of “View Monitoring Report” in the menu 810, a report may be displayed on an interface such as the historical data viewing element 850. The historical data viewing element 850 includes historical data that has been monitored. FIG. 19 shows an example of the historical data viewing element 850. Through the historical data viewing element 850, it is convenient for users to query historical monitoring data at any time. The display content of the historical data viewing element 850 may be determined according to user requirements.

The user interface described with reference to FIGS. 14 to 19 may be integrated into the user interface of sample processing, as shown in FIG. 20. In the example shown in FIG. 20, the option of “operation cleaning and monitoring after processing” may also be provided in the settings window. This option is for the user to choose before processing the sample. Once the user selects this option in the setting window, cleaning and monitoring are automatically performed after processing the sample, without waiting for the user's instructions or settings. In addition, in the example shown in FIG. 20, other program options may also be provided in the setting window, for example, “no cleaning”, “cleaning only”, “cleaning and monitoring”. Although not shown in FIG. 20, then, it should be understood that the program options may also include an option specifying that only monitoring should be performed (e.g., an option specifying “monitoring only”).

Control elements may be displayed in the user interface or various elements, for example, including but not limited to “Switch on”, “Start”, “Stop”, “Interrupt”, “Repeat”, “Close”, “Apply”, “Cancel”, etc., depending on user requirements. The control element may be in the form of one or more control buttons, for example, as shown at the bottom of the windows in FIGS. 16 to 19.

The above system or method may be implemented by the control unit 40. The control unit 40 in the present application may include a processor implemented as a computer or a computing system. The method of operating and cleaning the sample processing instrument and the method of monitoring the cleaning of the sample processing instrument described herein may be implemented by one or more computer programs executed by the processor of the computer. The computer programs include processor-executable instructions stored on a non-transitory tangible computer-readable medium. The computer programs may also include the stored data. Non-limiting examples of the non-transitory tangible computer-readable medium are non-volatile memory, magnetic storage devices, and optical storage devices.

The term computer-readable medium does not include transient electrical or electromagnetic signals that propagate by means of the medium (such as on a carrier); the term computer-readable medium may therefore be considered to be tangible and non-transitory. Non-limiting examples of non-transitory tangible computer-readable medium are non-volatile memory (such as flash memory, erasable programmable read-only memory or mask read-only memory), volatile memory (such as static random access memory circuit or dynamic random access memory), magnetic storage medium (such as analog or digital magnetic tapes or hard drives), and optical storage medium (such as CD, DVD, or Blu-ray Disc).

Although the present application has been described with reference to exemplary embodiments, it should be understood that the present application is not limited to the specific embodiments described and illustrated herein. Without departing from the scope defined by the claims, those skilled in the art can make various changes to the exemplary embodiments. Provided that there is no contradiction, the features in the various embodiments can be combined with each other. Alternatively, a certain feature in the embodiment may also be omitted.

1. A method for operating and monitoring the cleaning of a sample processing instrument, comprising steps, performed by a control device, of:
directing a first sample through a flow cell in the sample processing instrument, wherein the first sample comprises first particles;
processing the first sample;
cleaning the flow cell of the sample processing instrument with a cleaning agent;
measuring a carryover amount in the flow cell after the cleaning, wherein the carryover amount comprises a measurement associated with an amount of the first particles remaining in a measurement region of the flow cell;
comparing the measured carryover amount against a predetermined target value, wherein the target value corresponds to a value indicative of a cleaning requirement; and
determining, based on the comparison, whether the cleaning requirement is met.

2. The method according to claim 1, further comprising:
repeating the cleaning step when it is determined that the cleaning requirement is not met; and
stopping a cleaning process when it is determined that the cleaning requirement has been met or when a number of cleaning cycles reaches a maximum threshold.

3. The method according to claim 1, wherein the target value is input by a user.

4. The method according to claim 1, wherein the cleaning step comprises:
selecting the cleaning agent from a plurality of cleaning agents configured to clean the flow cell.

5. (canceled)

6. The method according to claim 1, wherein the measuring step comprises:
pumping a monitoring solution through the flow cell;
directing an optical beam toward the flow cell; and
measuring light scattered from within the flow cell, wherein the measured light corresponds to the carryover amount in the flow cell.

7. The method according to claim 6, wherein the monitoring solution is different from the cleaning agent.

8. The method according to claim 6, wherein the carryover amount comprises a count of the first particles, a carryover rate of the first particles, or a concentration of the first particles within the flow cell.

9. (canceled)

10. The method according to claim 6, further comprising calculating, by the control device, based on the measured carryover amount, at least one of: 1) a value representative of relevance of the carryover amount to the monitoring solution; and 2) a value representative of relevance of the carryover amount after cleaning and an amount of the first particles in a sample before cleaning.

11. (canceled)

12. The method according to claim 1, further comprising:
directing a second sample through the sample processing instrument following the determination that the cleaning requirement is met; and
processing the second sample.

13. The method according to claim 12, wherein the second sample is directed through the sample processing instrument automatically by the control device in response to the determination that the cleaning requirement is met.

14. (canceled)

15. The method according to claim 1, wherein the sample processing instrument is a flow cytometer, and wherein processing the first sample comprises determining one or more properties of the first particles in the first sample by directing an optical beam toward the flow cell and measuring light emitted or scattered from within the flow cell.

16-19. (canceled)

20. A method for operating and monitoring the cleaning of a sample processing instrument, comprising, by a computing system associated with the sample processing instrument:
displaying, on a user interface, a menu comprising at least one next-activity element;
displaying, on the user interface, a parameter setting element in response to a user selection of the at least one next-activity element, wherein the parameter setting element is configured to set a target carryover amount in a flow cell of the sample processing instrument;
receiving a user input at the parameter setting element, wherein the user input specifies the target carryover amount;
receiving carryover data corresponding to a measurement of particles present in a monitoring solution within the flow cell;
deriving an actual carryover amount according to the received carryover data; and
displaying, on the user interface, one or more monitoring elements representing the received carryover data, the actual carryover amount and/or the target carryover amount.

21. The method according to claim 20, further comprising:
determining a cleaning level by comparing the actual carryover amount with the target carryover amount; and
displaying, on the user interface, the cleaning level,
wherein the cleaning level comprises a first level indicating that a cleaning requirement is met and a second level indicating that the cleaning requirement is not met.

22. The method according to claim 21, further comprising:
when the second level is determined, repeating a cleaning cycle and then a monitoring cycle until maximum cleaning cycles are reached,
wherein receiving the user input comprises inputting parameters associated with the cleaning cycle and the monitoring cycle at the parameter setting element, and wherein the parameters comprise the maximum cleaning cycles.

23-26. (canceled)

27. The method according to claim 20, wherein the parameter setting element is further configured to receive one or more user inputs setting cleaning standards for particular samples to be processed by the sample processing instrument.

28. (canceled)

29. The method according to claim 20, further comprising:
displaying, on the user interface, a setting-applicable-sample element in response to a user selection of the at least one next-activity element, wherein the setting-applicable-sample element is configured to specify samples to be monitored with the same user input at the parameter setting element; and
receiving at the setting-applicable-sample element a user input to specify the samples to which the same user input at the parameter setting element is applied.

30-34. (canceled)

35. A system for operating and monitoring the cleaning of a sample processing instrument, comprising:
a fluid pipeline communicating fluid sources to a flow cell of the sample processing instrument;
a pump arranged in the fluid pipeline; and
a control device configured to:
direct a first sample through the flow cell in the sample processing instrument, wherein the first sample comprises first particles;
process the first sample;
control the pump to pump a cleaning agent through the fluid pipeline for cleaning the flow cell, and pump a monitoring solution through the fluid pipeline;
measure a carryover amount in the cleaned flow cell, wherein the carryover amount comprises a measurement associated with an amount of the first particles remaining in a measurement region of the flow cell;
compare the measured carryover amount against a predetermined target value, wherein the target value corresponds to a value indicative of a cleaning requirement; and
determine, based on the comparison, whether the cleaning requirement is met.

36. The system according to claim 35, wherein the control device is further configured to: repeatedly clean the flow cell when it is determined that the cleaning requirement is not met; and stop a cleaning process when it is determined that the cleaning requirement has been met or when a number of cleaning cycles reaches a maximum threshold.

37. The system according to claim 35, further comprising a switching device, wherein the switching device is configured to enable the pump to be in fluid communication selectively with a sample needle fitted in the flow cell or a sample source of the fluid sources.

38. The system according to claim 37, wherein the switching device comprises a three-way valve including a first port connected to the pump, a second port connected to the sample needle and a third port connected to the sample source, and wherein the three-way valve is switched between a first position allowing the pump to communicate with the sample needle and a second position allowing the pump to communicate with the sample source.

39-43. (canceled)
